(19) United States
(12) Patent Application Publication
(10) Pub. No.: US 2008/0259912 A1
(43) Pub. Date: Oct. 23, 2008

(54) ASSISTED WIRELESS TRANSMIT/RECEIVE UNIT PAGING AND CALL SESSION ROUTING

(75) Inventors: Jin Wang, Central Islip, NY (US); Mohammed Sammour, Montreal (CA); Peter S. Wang, E. Setauket, NY (US); Rajat P. Mukherjee, Montreal (CA); Shankar Somasundaram, Deer Park, NY (US); Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/103,905

(22) Filed: Apr. 16, 2008

Related U.S. Application Data
(60) Provisional application No. 60/912,622, filed on Apr. 18, 2007.

(51) Int. Cl. H04L 12/64

(52) U.S. Cl. 370/356

(57) ABSTRACT

A method and apparatus are disclosed for communicating with a Wireless Transmit/Receive Unit in wireless communications. The WTRU, capable of communicating in a 3GPP network and a non-3GPP network, receives messages with the assistance of the non-3GPP network through a Paging Entity.

### CROSS REFERENCE TO RELATED APPLICATIONS

This application claims the benefit of U.S. provisional application No. US60/912,622 and having a filing date of Apr. 18, 2007, which is incorporated by reference as if fully, set forth.

### BACKGROUND

The Third Generation Partnership Project (3GPP) has lately initiated the Long Term Evolution (LTE) program to bring new technology, new network architecture, new configurations, and new applications and services to the wireless cellular network in order to provide improved spectral efficiency reduced latency, and better utilization of radio resources, resulting in faster user experiences and richer applications and services with less cost. A plurality of heterogeneous wireless communication networks currently co-exist. Each network uses a different radio access technology (RAT) adapted for the specific services provided by the particular network. 3GPP systems are the dominant types of currently deployed wireless communication systems. LTE is an evolution of the radio interface and the radio network architecture of 3GPP systems.

As technology advances, many of today's wireless transmit/receive units (WTRUs) are equipped with non-3GPP radio access (e.g. Wireless Local Area Network, WLAN) transmission/receiving (Tx/Rx) capability in addition to a standard second generation/third generation (2G/3G) or LTE mobile telecom Tx/Rx capability. Besides the 3GPP and 3GPP LTE networks, non-3GPP systems, (such as fixed broadband wireless systems, have also been proposed and deployed. The non-3GPP systems include WiMAX, (i.e., IEEE 802.16), HIPERMAN, WiBro, or the like.

Similarly, in today's commercial or office buildings/places or even residential/home areas, non-3GPP radio access technology (e.g. WLAN) and communication environments are widely deployed and also well networked within the urban and/or sub-urban mobile telecom networks.

Due to situations related to geographical features, a building's architecture/layout, material wall/floor insulation, or temporary blockage of radio transmissions, there may be areas or a particular office area or a special location which experiences mobile telecom blinding. In these areas or blind spots, mobile telecom transmission/reception coverage is not uniform or at certain spots is not good enough for the mobile terminal/handsets to receive normal paging signals or to conduct a normal call session. It may also be possible that the cell is located in a high traffic area, such as in a shopping mall and the system has no capacity left for paging the WTRUs in the cell or for carrying out a normal call session.

As a plurality of heterogeneous networks are concurrently deployed, multi-mode WTRUs having at least two radio units to support at least two different Radio Access Technologies (RATs) have become available. Depending on the capability of the WTRU, the multi-mode WTRU may communicate with two Radio Access Networks (RANs) simultaneously and may selectively receive a service through one of the RANs. The multi-mode WTRU may also select a preferred RAN among a plurality of available RANs and may perform a handover from one RAN to another.

It is highly possible that some non-3GPP radio access technologies, such as wireless LAN (WLAN) assisted mobile telecom paging or even call session operation, are available to provide coverage at these problem/blind spots and have strong capacity for Tx and Rx at the required throughput. Under these circumstances, the non-3GPP radio access technology will be very helpful to the end user and the system with respect to those problem/blind spots as well as to the temporary 3GPP radio access network congestion and will provide an overall increase in the call completion rate.

Therefore, there exists a need for a method and apparatus to assist in eliminating mobile telecom blinding in these areas.

### SUMMARY

A method and apparatus are disclosed for a Wireless Transmit/Receive Unit (WTRU) for receiving calls or messages with the assistance of a non-3GPP network through a Paging Entity.

### BRIEF DESCRIPTION OF THE DRAWINGS

A more detailed understanding may be had from the following description, given by way of example and to be understood in conjunction with the accompanying drawings wherein:

FIG. 1 is a diagram of WTRU Paging assisted by Non-3GPP IP Access/WLAN Network Architecture;

FIGS. 2A-2C show Systems Operations on Non-3GPP IP Access/WLAN Assisted LTE Paging or Call Session Routing;

FIG. 3 is a process flow diagram of a Direct N3G/WLAN Paging to the WTRU; and

FIG. 4 is a WLAN Assisted WTRU Paging Alert/Call Session Routing Operating Model.

### DETAILED DESCRIPTION

When referred to hereafter, the terminology “wireless transmit/receive unit (WTRU)” includes but is not limited to a user equipment (WTRU), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

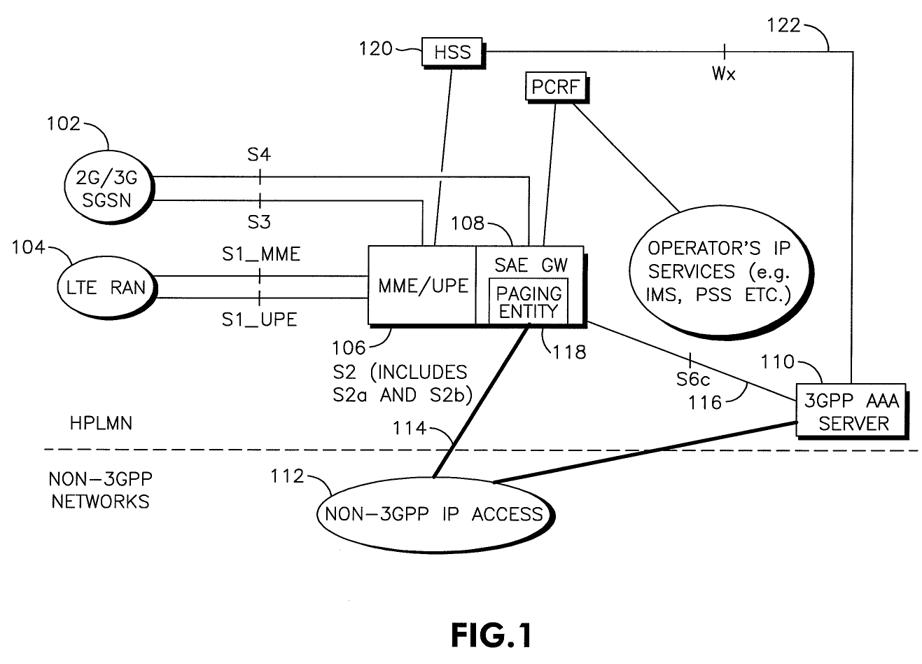

FIG. 1 illustrates a wireless communication system architecture and related method of non-3GPP radio access assisted long-term evolution (LTE). As shown in FIG. 1, the wireless communication system includes a 2G/3G Service GPRS Support Node (SGSN) 102, a LTE radio access network (RAN) 104, Mobile Management Entity/User Plain Entity (MME/UPE) 106, a System Architecture Evolution gateway (SAE GW) 108, a 3GPP Access, Authorization and Accounting (AAA) server 110, and a non-3GPP (N3G), IP Access interface 112.

In accordance with FIG. 1, the SAE GW includes a Paging Entity 118. An LTE wireless transmit receive unit (WTRU) is connected to the SAE GW and the MME/UPE through the LTE RAN.

As shown in FIG. 1, the SAE GW (also known as an IASA—inter access service anchor) connects to the Non-3GPP IP access network (N3G network) nodes on the S2 interface 114 and the SAE GW 108. Also the SAE GW 108 connects to the 3GPP AAA Server on the S6c interface 116. Therefore, the SAE GW is the anchor point for the LTE/2G3G and the N3G (e.g. WLAN) services. It is also straightforward to check the mobile handsets (WTRU) authentication with the AAA Server 110 (via S6C). In the event that the N3G is trusted, the IP access 112 connects to the SAE GW 108 via the S2a (114) interface directly. In the event that the non-3GPP IP access is un-trusted, then the IP access connects to the SAE GW 108 via an Packet Data Gateway (e-PDG) and S2b (114) interface. Hence the Non-3GPP IP access encapsulates both these possibilities and the S2 interface shown in FIG. 1 includes both the S2a (for trusted) and S2b (for un-trusted).

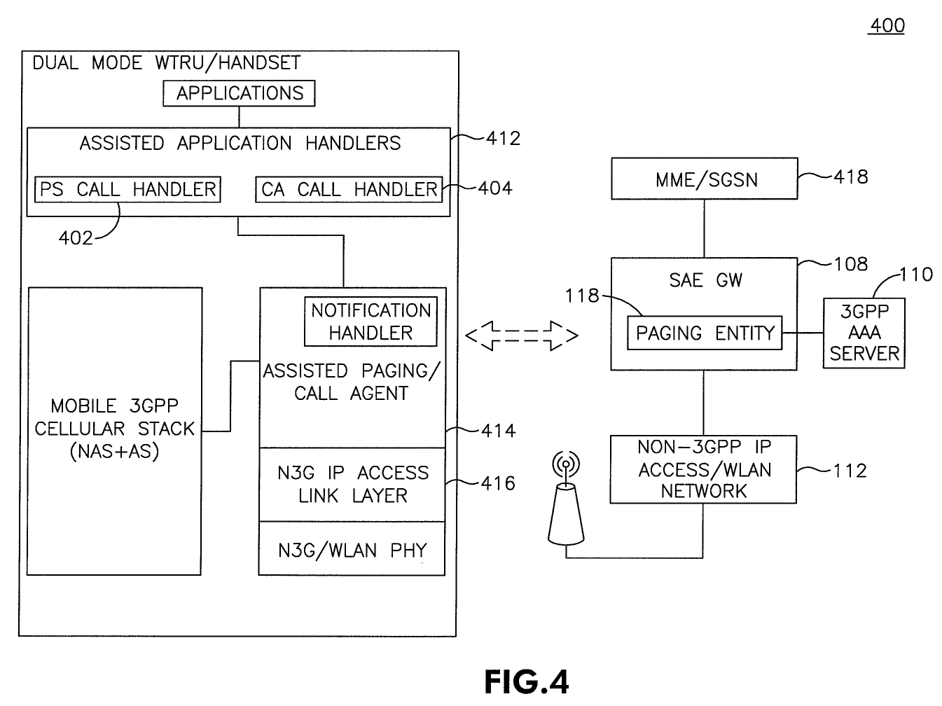

FIG. 4 shows a dual mode WTRU 400, allowing it to communicate in both the 3GPP network and the N3G network. Referring to FIG. 4, the WTRU includes an assisted application handler 412, and an assistant paging/call agent 414. The assisted application handler 412, (which includes a PS call handler 402 and a CS call handler 404) bridges and handles the direct N3G call service request from the 414 to real applications such as voice coder/decoder, video application protocol stack etc.

The assisted application handlers 412, PS call handler 402 and CS call handler 404, bridge the assisted paging/call agent 414 to the service applications in the WTRU for call sessions or paging sessions in the WTRU. The assisted paging/call agent 414 is at the top of the N3G IP access protocol stack (416) and interfaces with the 3GPP mobile network protocol, and comprises a notification handler for alerting the user that there is a live incoming call and transmits the WTRUs response back to the network. The paging entity 118 in the SAE GW 108 communicates peer to peer with the assisted paging/call agent 414 at the same protocol level.

The paging-entity 118 is capable of receiving a MME/SGSN 418 indication that the 2G/3G/LTE initial paging effort was unsuccessful, and that the paged handset is equipped with N3G capability and Non-3GPP IP Access/WLAN-related identity/credentials. The paging-entity is also able to query the 3GPP AAA server 110 for the N3G network authentication results against the paged WTRU, to determine, based on the WTRU capability from the MME/SGSN 418 and the connected N3G network capability. The querying is done to determine whether to only route the paging message through the Non-3GPP IP Access/WLAN and thereby alert the WTRU over IP and subsequently send the paging message to the Paging Controller of the non-3GPP Radio Access Technology (RAT); or to prepare for connecting the WTRU through the Non-3GPP/WLAN with the caller network for a call session routing as disclosed hereinafter.

The Paging-Entity 118 in SAE GW 108 can route the paging request (via IP or through a paging controller in non-3GPP RAT), or initiate paging for call session routing to the N3G network. As an example of routing, the Paging Entity 118 may incorporate/be a part of or have an interface between itself and the Paging Controller responsible for paging in a WiMAX network. Any page to a cellular 2G/3G/LTE network that needs to be routed to WiMAX (or vice versa) can be sent over this interface along with any associated control signaling.

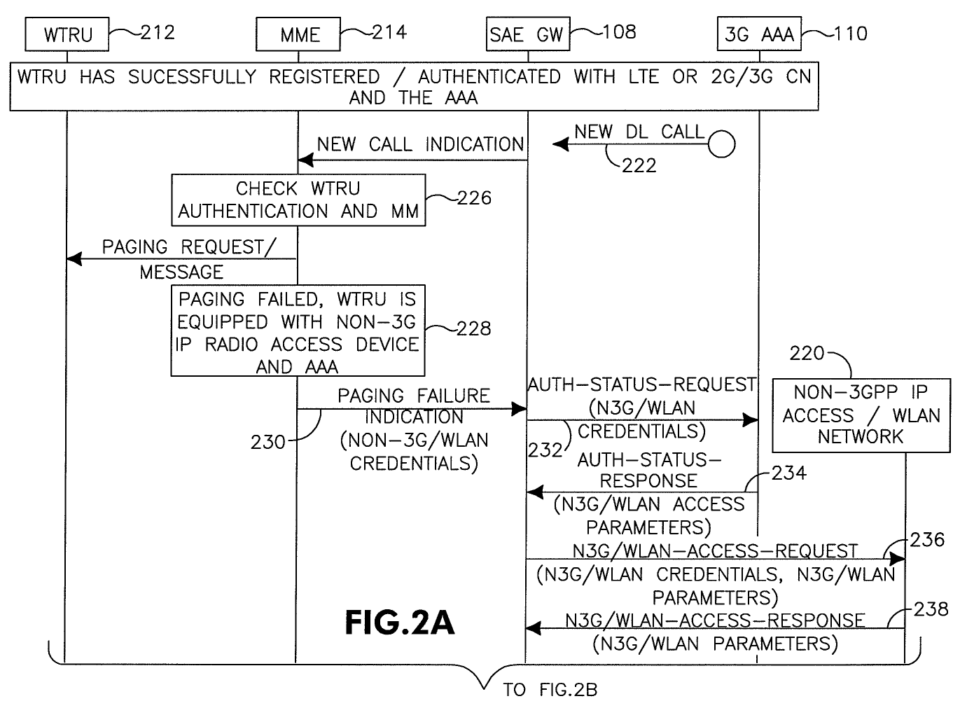

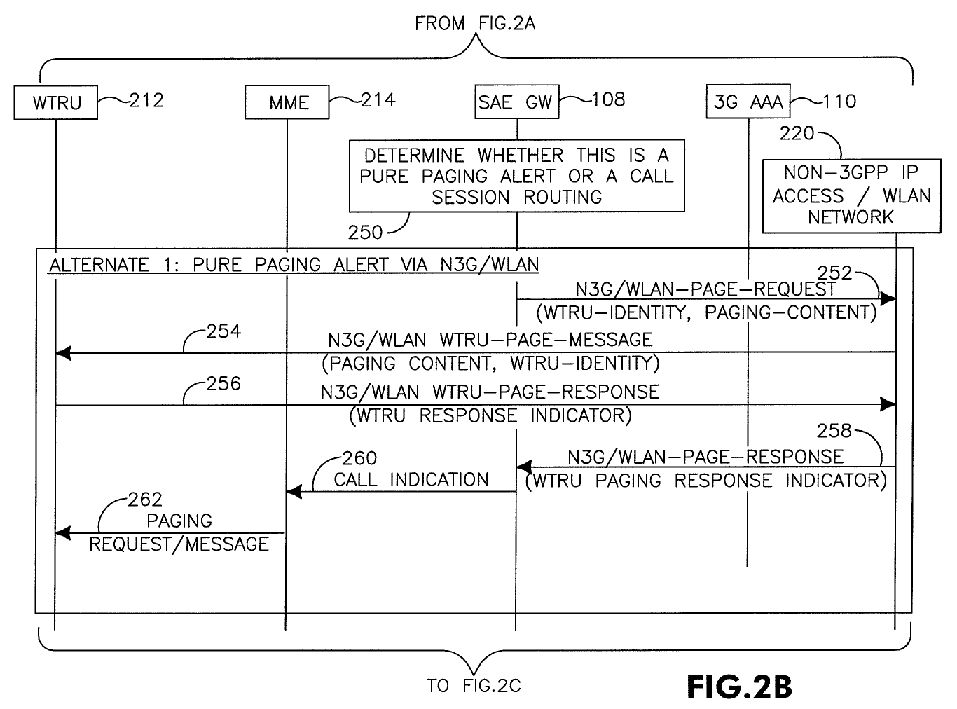

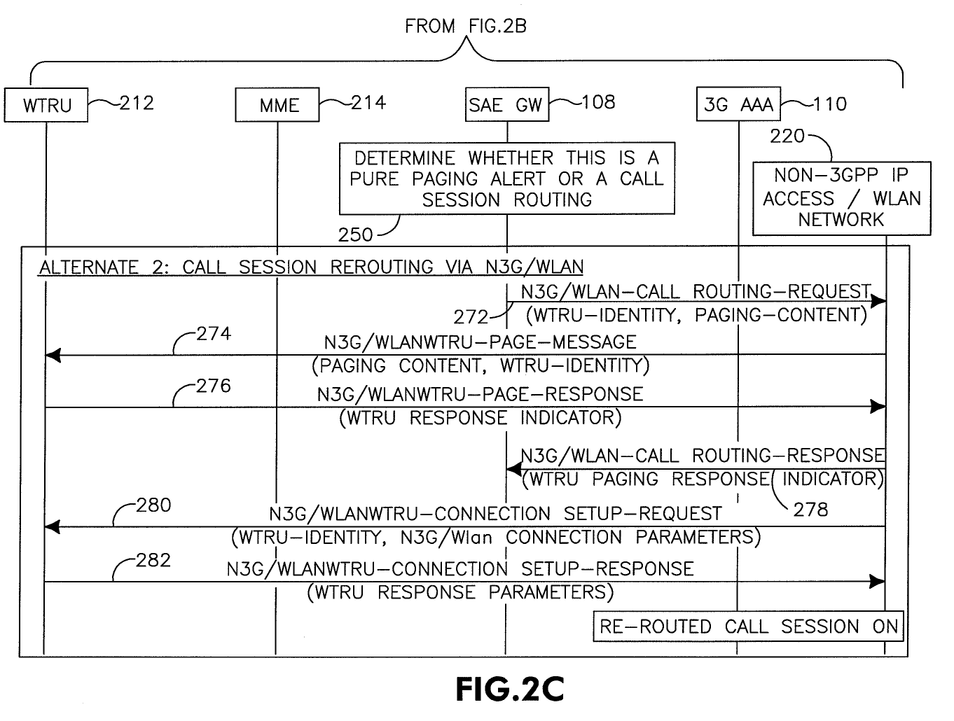

From the LTE system's perspective, and assuming that the WTRU is equipped with both a telecom mobile Tx/Rx device and a Non-3GPP IP Access/WLAN Tx/Rx device and is capable of operating them simultaneously, the following system-wide scenarios (as represented by FIGS. 2A through 2C) are involved with the Non-3GPP IP Access/WLAN assisted LTE paging or LTE call session routing.

FIG. 2A illustrates a flow diagram of schematic operation of the Non-3GPP IP Access/WLAN Assisted LTE paging or call session routing method. Referring to FIG. 2, the WTRU/mobile handset 212 is connected to the Core Network (CN) and preferably registered with the 3GPP AAA server 110 via its Non-3GPP IP Access/WLAN device. Accordingly, when a WTRU in idle mode (as it relates to its mobile telecom part) enters a “blind/dead spot” where the 3GPP network coverage for the WTRU is effectively lost, the CN network may not be aware of this (depending on the periodic Routing Area (RA)/Tracking Area (TA)/Location Area (LA) update timer) and, therefore still considers the WTRU ready to take an incoming call.

An incoming call 222 from the mobile telecom network (the 3GPP network) for the WTRU 212 associated with a mobile telecom number arrives at the SAE GW 108 associated with the Paging handling entity 118, and then to MME/SGSN 214 which starts to page the WTRU 212 in the 3GPP network.

The 3GPP network paging to the WTRU 212 in the blind spots is not successful, and the mobile telecom network (SGSN/MME) is notified about an unsuccessful paging result 228. The mobile telecom network (MME/SGSN), through the Home Subscriber Server (HSS) 120, FIG. 1 and the 3GPP AAA server 110, then determines the WTRU capabilities.

If the WTRU is Non-3GPP IP Access/WLAN-equipped, the mobile telecom network (MME/SGSN) then provides the SAE GW Paging-entity (118) with the Non-3GPP IP Access/WLAN-capability/info of the WTRU 212 in step 228.

The Paging Entity 118 in SAE GW 108 then checks with the 3GPP AAA server 110 for the WTRU's authentication results for the Non-3GPP IP Access/WLAN, N3G Network 220, including a status request 232. The 3GPP AAA server 110 then responds to the paging entity with the WTRUs N3G parameters 234.

If the result of the check is positive, the SAE GW Paging-Entity 118 transmits an access request 236 to the N3G Network 220 for the N3G networks capability/readiness to carry a routed call session or to carry only a paging message to the WTRU 212. If it does not have the ability to page the WTRU the network may send the paging message as an IP packet to the WTRU based on WTRU capabilities. This preferably necessitates some IP-level negotiations with the WTRU. If the radio access technology (RAT) can handle the call instantly (e.g. WiMAX network has WTRU in connected mode) then the Paging Entity/SAE GW might choose to route the session to the access RAT at that time without paging and leave it up to the target RAT to handle control functions.

If the result of the check with the 3GPP AAA server 110 is not positive, the 3GPP AAA server 110 will notify the calling entity about the paging failure 238.

The paging entity 118 of the SAE GW 108 then determines whether a call session connection is to be established for the call session routing or simply a paging notification/message 250 needs to be sent.

In FIG. 2B, a first alternate of a method for communicating a paging message is shown.

The SAE GW Paging Entity 118 sends a proper paging command 252 to the N3G network for a paging alert to the WTRU 212. The network sends a N3G/WLAN paging message 254 to notify WTRU 212 about the LTE/2G/3G paging. It is preferable that the paging message 254 be done over IP, thereby minimizing any proposed changes to the underlying non-3GPP access network.

However, in the event that the non-3GPP access network has its own paging mechanism, the controlling entities may choose to implement the paging message in their own RAT-specific manner. For example, a WLAN Access Point (AP) may choose to indicate on its beacon a period of silence so as to be able to send the paging message directly without contending for the WLAN channel. In such a case, in addition to indicating a silence period on the beacon, the AP, as part of its configuration, could indicate to all WTRUs/Stations (STAs) in its network a designated silence period during which they are to listen to paging. The designated silence period could be, as an example, a function of the AP point name such that every network could have its own silence period if it so desires. The WTRU then responds with a N3G/WLAN WTRU Paging Response message 256 for a positive result. The N3G network then sends a N3G/WLAN-Paging Response 258 to the SAE GW Paging-entity 118 the results of the N3G WTRU paging alert.

The SAE GW Paging Entity 118 may then start the regular LTE paging 260 and 262 through the mobile telecom interface (via MME SGSN), assuming the WTRU has received the paging alert and has responded positively, by moving towards a “live spot” for the regular paging again. A regular call session may begin after the LTE/2G/3G paging is received by the WTRU.

If the N3G network and the WTRU 212 are capable of supporting the incoming call from the Non-3GPP IP Access/WLAN interface (N3G interface), a call session routing can be completed.

In FIG. 2C, a second alternate of a method for communicating a call session routing is shown.

The SAE GW paging entity 118 sends to the N3G network 220 a call session routing request message 272. The N3G network then sends to the WTRU 212 a paging message 274, including parameters indicating to the WTRU (Assisted Paging/Call Agent) that data-path establishment over N3G is needed for the paged call. The WTRU Assisted Paging/Call Agent appropriately responds 276 with the necessary parameters for the call session routing.

The N3G network 220 responds by way of a N3G call routing response message 278 to the SAE GW 108 paging entity for call session routing (and as result of this message, the data-path between the SAE GW through the N3G network for the call is established).

The N3G network 220 by way of the N3G WLAN connection setup request 280, configures the WTRU and other nodes/interface within the N3G network on the path way for the re-routed call session, the N3G interface bearer and the landline data bearers.

The WTRU completes the connection setup and responds with the N3G/WlanWTRU-ConnectionSetup-Response 282 to the N3G network. With this message, the N3G network switches on the data-path for the re-routed call session to the WTRU.

In accordance with the above scheme, when the WTRU is registered to both the 3GPP HSS and to the 3GPP AAA server, the core network systems could make use of the Wx interface (AAA-HSS: 122) to reconcile/compare location information for the WTRU within both networks (N3G and 3GPP), and user profile information detailing the WTRU's capabilities with regards to page alerting only or full call session capabilities.

If the SAE GW Paging Entity knows all this information a priori, it is able to choose whether the incoming call paging should be executed directly on both N3G network and 3GPP network simultaneously without having to attempt one and then the other.

It should be noted that pages to the WTRU can be answered through both interfaces (3GPP and N3G). Preferably, either the WTRU or the SAE GW Paging Entity decides what interface/network (3GPP and N3G) should be used, based upon, for example, subscriber policy, subscriber location and supported Quality of Service (QoS).

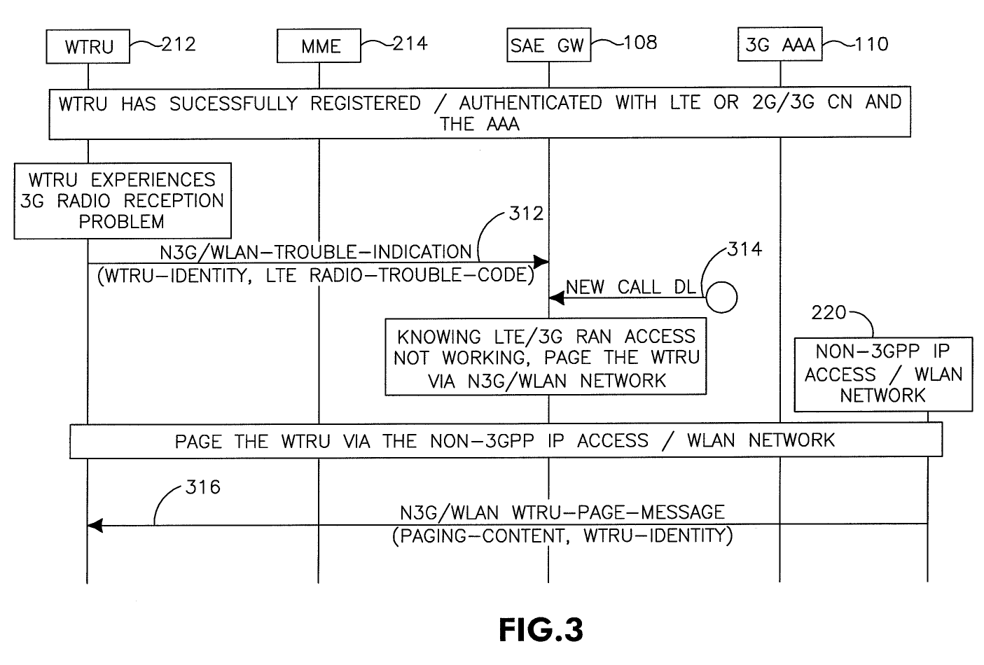

FIG. 3 describes a flow diagram for Direct N3G/WLAN Paging to the WTRU. The WTRU Assisted-Paging/Call-Agent can get the information (using for example 802.21/WLAN event service) with regard to the poor radio conditions experienced by the UMTS/LTE radio coming from the UMTS/LTE lower layers.

The information about the WTRU's poor LTE reception condition could be sent by way of a trouble indication message 312 via the N3G network to the Paging Entity in the SAE GW. Therefore, when the incoming call 314 to the particular WTRU arrives at the SAE GW, the Paging Entity could decide to page or perform call routing with the WTRU much faster through the N3G network 316 directly without going through the LTE RAN paging than the failure scenario as described above.

The Assisted-Paging/Call-Agent may get LTE/2G/3G poor radio reception status from the control/protocol stack and inform the SAE GW 108 Paging Entity about the status so the SAE Paging Entity can page the WTRU directly via the Non-3GPP IP Access/WLAN network.

For the call session re-routing, the 3GPP protocol stack in FIG. 4 may be bypassed by the handlings between the SAE GW Paging Entity and the Assisted Paging/Call-Agent at the WTRU with the help of the Assisted Application Handlers.

From the systems aspect of the scenarios, an operating protocol model is shown in FIG. 4. The WTRU assisted paging/call agent 414 is at the top of the non-3GPP IP access protocol stack and has interface with the 3GPP mobile network protocol 416. The Paging Entity in SAE Gateway 108 communicates peer to peer with the Assisted-Paging/Call-Agent 414 in WTRU at the same protocol level, (a pseudo pair of protocol peers).

The above two entities understand the syntax and semantics of the peer to peer messages between the SAE Gateway and the WTRU Assisted Paging/Call Agent, such as those defined in FIG. 2, the N3G/WLANWTRU-Paging-Request/Response and the N3G/WLANWTRU-ConnectionSetup-Request/Response, etc.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (WTRU), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit/receive unit (WTRU) comprising:
an assisted paging/call agent for communicating with a Paging Entity;
an assisted applications handler to bridge connections for the assisted paging/call agent for service applications; and
the assisted paging/call agent including a notification handler, the notification call handler for alerting the WTRU to an incoming call and for transmitting a WTRU response.

2. The WTRU of claim 1, wherein the assisted paging/call agent is within a system architecture with a System Architecture Evolution Gateway (SAE GW), connected to the Paging Entity in the SAE GW via a non third generation partnership project (N3G) network.

3. The WTRU of claim 1, wherein the assisted paging/call agent gets a radio reception status from a third generation partnership project (3GPP) radio control/protocol stack and informs the Paging Entity about the radio reception status via N3G network.

4. The WTRU of claim 1, wherein the assisted paging/call agent receives network paging/reception information from a Non-Third Generation Partnership Project (N3G) IP Access network.

5. A Paging Entity for performing a call alert or a call routing procedure for a wireless transmit/receive unit (WTRU), the Paging Entity comprising:
a transmitter;
a receiver;
a processor; and
a memory configured to store computer readable instructions that, when executed by the processor, causes the processor to determine that an initial paging request at a WTRU is unsuccessful based upon a signal received by transceiver, to determine that a paged WTRU is equipped with Non-third generation partnership project (N3G) capability and N3G IP Access related identity and credentials and to evaluate from the indication, ability of the WTRU to accept a paging/call message.

6. The Paging Entity of claim 5, wherein the transceiver receives an indication about an initial paging request from a mobile management entity/signaling GPRS support node (MME/SGSN).

7. The Paging Entity of claim 5, wherein the processor routes the paging request via IP or thorough a paging controller in N3G radio access technology (RAT).

8. The Paging Entity of claim 5, wherein the processor initiates the call session routing through the N3G IP Access network.

9. The Paging Entity of claim 5, wherein the processor determines whether to route paging message through N3G IP Access to alert WTRU over IP.

10. The Paging Entity of claim 5, wherein the processor determines whether to prepare for connecting the WTRU through N3G IP Access with the caller network for a call session routing.

11. A Paging Entity for performing a call alert or a call routing procedure for a wireless transmit/receive unit (WTRU), the Paging Entity comprising:
a transmitter;
a receiver;
a processor; and
a memory configured to store computer readable instructions that, when executed by the processor, causes the processor to transmit, through the transmitter, a paging command for a paging alert to the WTRU, receiving a positive response from the WTRU by way of a paging response message, receive from non-third generation partnership project (N3G) IP Access network the result of N3G paging alert, initiate regular mode of paging, when the WTRU has received the paging alert, receive indication from WTRU that it has started to move towards an area having better reception and initiate a regular call session when the paging is received.

12. The Paging Entity of claim 11, wherein the processor causes the transmitter to transmit a paging command to be sent over IP to N3G IP Access network.

13. The Paging Entity of claim 11, wherein the processor causes the transmitter to transmit the paging command to be sent over IP to N3G IP Access network and paging is done over a non-mobile-telecom-interface.

14. The Paging Entity of claim 11, wherein the processor determines the WTRU capabilities for alerts or full call session by registering the WTRU with a Home Subscriber Server (HSS) and to a authentication, authorization, and accounting (AAA) server.

15. A Paging Entity for performing a call alert or a call routing procedure for a wireless transmit/receive unit (WTRU), the Paging Entity comprising:
a transmitter;
a receiver;
a processor; and
memory configured to store computer readable instructions that, when executed by the processor, causes the processor to determine that the WTRU is capable of supporting an incoming call from a IP Access network, initiate a IP Access network via the transmitter to send a paging message to the WTRU and receive from the WTRU the necessary parameters for call session routing, initiate a Non-third generation partnership project (N3G) IP Access network to respond for the call session routing, configure the N3G IP Access network to send a command for configuring the WTRU, determine that the WTRU has completed a connection setup and initiate the IP Access network to switch on the data-path for the re-routed call session to the WTRU.

16. The Paging Entity of claim 15, wherein the processor registers the WTRU with a Home Subscriber Server (HSS) and to an authentication, authorization, and accounting (AAA) server.

17. The Paging Entity of claim 15, wherein the memory has stored information regarding the WTRU location with a third generation partnership project network and a N3G network for execution of the paging call.

18. A method for performing a call alert or a call routing procedure by a Paging Entity for a wireless transmit/receive unit (WTRU), the method comprising:
determining that an initial paging request at a WTRU is unsuccessful and that the paged WTRU is equipped with Non-third generation partnership project (N3G) capability and N3G IP Access related identity and credentials; and
evaluating from the indication, ability of the WTRU to accept a paging/call message.

19. The method of claim 18, wherein the indication about an initial paging request is received from a mobile management entity/signaling GPRS support node (MME/SGSN).

20. The method of claim 18, wherein the routing of the paging request takes place via IP or thorough a paging controller in N3G radio access technology (RAT).

21. The method of claim 18, wherein the call session routing is initiated through the N3G IP Access network.

22. The method of claim 18, wherein the Paging Entity determines whether to route paging message through N3G IP Access to alert WTRU over IP.

23. The method of claim 18, wherein the Paging Entity determines whether to prepare for connecting the WTRU through N3G IP Access with the caller network for a call session routing.

24. A method for performing a call alert or a call routing procedure by a Paging Entity for a wireless transmit/receive unit (WTRU), the method comprising:
transmitting a paging command for a paging alert to the WTRU;
receiving a positive response from the WTRU by way of a paging response message;
receiving from non-third generation partnership project (N3G) IP Access network the result of N3G paging alert;
initiating regular mode of paging, when the WTRU has received the paging alert;
receiving indication from WTRU that it has started to move towards an area having better reception and initiate a regular call session when the paging is received.

25. The method of claim 24, wherein a paging command is sent over IP to N3G IP Access network.

26. The method of claim 24, wherein a paging command is sent over IP to N3G IP Access network and paging is done over a non-mobile-telecom-interface.

27. The method of claim 24, wherein there is a capability check made for alerts or full call session by registering the WTRU with a Home Subscriber Server (HSS) and to a authentication, authorization, and accounting (AAA) server.

28. A method for performing a call alert or a call routing procedure by a Paging Entity for a wireless transmit/receive unit (WTRU), the method comprising:
determining that the WTRU is capable of supporting an incoming call from a IP Access network;
initiating a IP Access network via the transmitter to send a paging message to the WTRU and receiving from the WTRU the necessary parameters for call session routing;
initiating a Non-third generation partnership project (N3G) IP Access network to respond for the call session routing;
configuring the N3G IP Access network to send a command for configuring the WTRU; and
determining that the WTRU has completed a connection setup and initiate the IP Access network to switch on the data-path for the re-routed call session to the WTRU.

29. The method of claim 28, wherein the processor registers the WTRU with a Home Subscriber Server (HSS) and to an authentication, authorization, and accounting (AAA) server.

30. The method of claim 28, wherein, wherein the memory has stored information regarding the WTRU location with a third generation partnership project network and a N3G network for execution of the paging call.
